(19) United States
(12) Patent Application Publication
(10) Pub. No.: US 2020/0354903 A1
(43) Pub. Date: Nov. 12, 2020

(54) Water cooling device for saw blade cooling and road cutting machine

(71) Applicant: WUHAN WANBANG LASER DIAMOND TOOLS CO., LTD., Wuhan, Hubei (CN)

(72) Inventors: Shaoying LIU, Wuhan, Hubei (CN); Huabin QI, Wuhan, Hubei (CN); Tao XIE, Wuhan, Hubei (CN); Jiadong PAN, Wuhan, Hubei (CN)

(21) Appl. No.: 16/640,339

(22) PCT Filed: Dec. 13, 2017
(86) PCT No.: PCT/CN2017/115876

§ 371 Date: Feb. 19, 2020

(30) Foreign Application Priority Data
Aug. 23, 2017 (CN) 201710731123.6

(51) Int. Cl. E01C 23/09; B23D 59/02

(52) U.S. Cl. CPC E01C 23/09; B27G 3/00; B23D 59/02

(57) ABSTRACT

A water cooling device for saw blade cooling and a road cutting machine. The water cooling device comprises a saw blade mounting shaft (12), a transmission shaft (14), a belt wheel (13), a fastening bolt (3), and a flange plate (10); the saw blade mounting shaft (12) comprises a central shaft (121) and a connecting seat (122); a first through hole (31) allowing water to flow into is formed in the fastening bolt (3); a second through hole (123) is formed in the central shaft (121); the fastening bolt (3) penetrates through the transmission shaft (14) to be butt-jointed with the central shaft (121); the first through hole (31) is in communication with the second through hole (123); the flange plate (10) is mounted on the central shaft (121); the saw blade (11) is positioned between the flange plate (10) and the connecting seat (122); at least one water outlet hole (124) is formed in the central shaft (121); the water outlet hole (124) is positioned between the flange plate (10) and the connecting seat (122); the water outlet hole (124) is in communication with the second through hole (123); a passage in communication with the water outlet hole (124) is reserved between the flange plate (10) and the saw blade (11); a passage in communication with the water outlet hole (124) is reserved between the connecting seat (122) and the saw blade (11). The road cutting machine comprises the water cooling device. The water cooling device can improve the cooling efficiency and save water resources.

### FIELD OF THE INVENTION

The invention refers to the technical field of saw blade cooling device, in particular to a water cooling device for saw blade cooling and a road cutting machine.

### BACKGROUND OF THE INVENTION

Saw blade is a tool for cutting solid materials. During the cutting operation, the saw blade frictionally generates heat with the object being cut. In order to ensure the life, sharpness and operating safety of the saw blade, it is often necessary to cool the working saw blade. At present, the saw blade is generally cooled by direct watering. For example, the road cutting machines in the market usually fix external water pipes near the periphery of the saw blade, and direct watering through the water pipe for saw blade cooling. The cooling water is poured on the saw blade from the outside, because of the high-speed rotation of the saw blade, a large amount of cooling water is thrown away, which not only results in a large amount of cooling water consumption and a waste of water resources, but also makes it take longer time for the saw blade to achieve the cooling effect, resulting in low cooling efficiency of the saw blade.

### SUMMARY OF THE INVENTION

In view of the defects existing in the prior art, the present invention is aimed at providing a water cooling device for saw blade cooling and a road cutting machine. The present invention can not only improve cooling efficiency, but also save water resources.

The present invention provides a water cooling device for a saw blade cooling, comprising a saw blade mounting shaft, a transmission shaft and a belt pulley, wherein a saw blade is mounted on the saw blade mounting shaft, the belt pulley is sleeved on the transmission shaft, a bearing is provided between the belt pulley and the transmission shaft, and the saw blade mounting shaft is fixed on one end of the belt pulley; wherein the water cooling device further comprises a fastening bolt and a flange plate, and the saw blade mounting shaft comprises a central shaft and a connecting seat;

the fastening bolt is provided with a first through hole for water to flow in, and the central shaft is provided with a second through hole, and the fastening bolt passes through the transmission shaft to be butt-jointed with the central shaft, so that the first through hole is communicated with the second through hole;

the flange plate is arranged on the central shaft, and the saw blade is located between the flange plate and the connecting seat; the central shaft is provided with at least one water outlet hole, which is located between the flange plate and the connecting seat and communicated with the second through hole; a passage in communication with the water outlet hole is reserved between the flange plate and the saw blade, and a passage in communication with the water outlet hole is reserved between the connecting seat and the saw blade.

On the basis of the above technical solution, a first water storage groove is provided on a side of the flange plate near the saw blade, and a cavity for storing water is formed between the first water storage groove and the saw blade; the edge of the flange plate is evenly provided with a plurality of first drainage grooves, which are in communication with the first water storage groove;

a second water storage groove is provided on a side of the saw blade mounting shaft near the saw blade, and a cavity for storing water is formed between the second water storage groove and the saw blade; the edge of the saw blade mounting shaft is evenly provided with a plurality of second drainage grooves, which are in communication with the second water storage groove.

On the basis of the above technical solution, when the flange plate and the connecting seat are arranged on both sides of the saw blade, the positions of the first water storage groove and the second water storage groove are opposite to each other and the first drainage groove and the second drainage groove are opposite to each other.

On the basis of the above technical solution, a sealing ring assembly is provided at the joint between the fastening bolt and the central shaft.

On the basis of the above technical solution, the seal ring assembly comprises a first seal ring, a second seal ring, and a third seal ring, wherein the first seal ring is a rubber seal ring, the second seal ring is a ceramic seal ring, and the third seal ring is a rubber seal ring, and the second seal ring is located between the first seal ring and the third seal ring.

On the basis of the above technical solution, a groove matching with the first sealing ring is provided on the transmission shaft, and the first sealing ring is placed in the groove.

On the basis of the above technical solution, a spring is sleeved on the central shaft, one side of the spring abuts on the connecting seat, and the other side abuts on the seal ring assembly.

On the basis of the above technical solution, the fastening bolt is provided with a water jacket for externally connecting to a water pipe, and the water jacket is communicated with the first through hole.

On the basis of the above technical solution, the flange plate is fixed on the central shaft through a nut, the connecting seat is fixed on the belt pulley through a plurality of screws, and the saw blade is fixed on the connecting seat through the saw blade positioning pin.

The present invention further provides a road cutting machine, which comprises the above water cooling device, wherein the saw blade is mounted on the water cooling device, which is fixedly connected to a motor of the road cutting machine through a fixing plate, the fixing plate is fixedly connected to the transmission shaft, and the fastening bolt passes through the fixing plate.

Compared with the prior art, the invention has the advantages as follows:

1. In the present invention, the fastening bolt is communicated with the central shaft of the saw blade mounting shaft, the cooling water enters between the flange plate and the connecting seat of the saw blade mounting shaft through the fastening bolt, and then by the inertial centrifugal force of the saw blade rotating, the water is thrown out along the passage for water to flow out between the flange plate and the saw blade, and between the connecting seat and the saw blade. The present invention can not only save water resources, but also improve cooling efficiency, thereby improving cutting efficiency.

2. In the present invention, the flange plate and the connecting seat of the saw blade mounting shaft are both provided with a water storage groove, and the edge of the flange plate and the connecting seat are both evenly provided with drainage grooves, which can ensure the uniform cooling of the saw blade and further improve the cooling efficiency.

3. The present invention only needs to connect the water pipe to the fastening bolt, and the cooling water can directly enter between the flange plate and the saw blade mounting shaft along the passage, so additional manual operation is not required, which improves the safety of the operation and saves water resources, thereby reducing the burden of transportation of cooling water for operation.

4. In the present invention, fastening bolts with holes are used, holes and grooves for water to flow out are provided on the saw blade mounting shaft, and grooves for water to flow out are provided on the flange plate. Therefore, the device of the present invention has simple structure and strong applicability.

### DESCRIPTION OF THE DRAWINGS

FIG. 1 shows a schematic structural diagram of the water cooling device for saw blade cooling in the embodiment of the present invention.

FIG. 2 shows a schematic structural diagram of the saw blade mounting shaft in the embodiment of the present invention.

FIG. 3 shows a schematic structural diagram of the flange plate in the embodiment of the present invention.

FIG. 4 shows a schematic structural diagram of the road cutting machine in the embodiment of the present invention.

### DETAILED DESCRIPTION OF THE EMBODIMENTS

The present invention will be further described below in detail with reference to the drawings in combination with the embodiments.

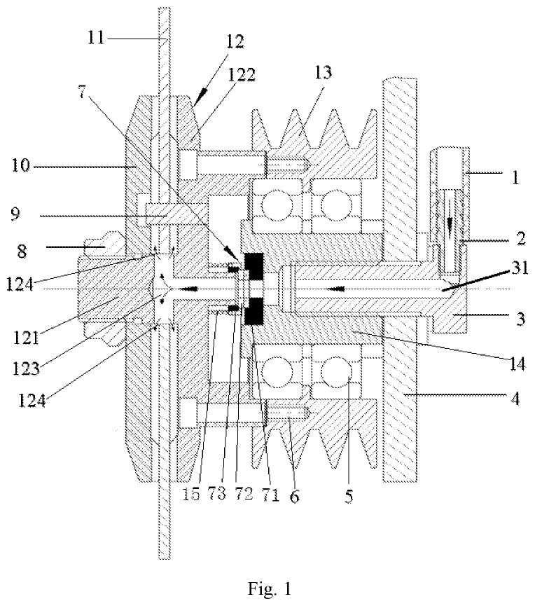

Referring to FIG. 1, the embodiment of the present invention provides a water cooling device for saw blade cooling. The water cooling device comprises a saw blade mounting shaft 12, a transmission shaft 14, and a belt pulley 13. The saw blade 11 is mounted on the saw blade mounting shaft 12, and the belt pulley 13 is sleeved on the transmission shaft 14. A bearing 5 is provided between the belt pulley 13 and the transmission shaft 14. The saw blade mounting shaft 12 is fixed on one end of the belt pulley 13. The water cooling device further comprises a fastening bolt 3 and a flange plate 10. The saw blade mounting shaft 12 comprises a central shaft 121 and a connecting seat 122. The fastening bolt 3 is provided with a first through hole 31 for water to flow in, the central shaft 121 is provided with a second through hole 123, and the fastening bolt 3 passes through the transmission shaft 14 to be butt-jointed with the central shaft 121, so that the first through hole 31 is communicated with the second through hole 123. The flange plate 10 is arranged on the central shaft 121, and the saw blade 11 is located between the flange plate 10 and the connecting seat 122. The central shaft 121 is provided with at least one water outlet hole 124, which is located between the flange plate 10 and the connecting seat 122. The water outlet hole 124 is communicated with the second through hole 123. One passage, which is communicated with the water outlet hole 124, is reserved between the flange plate 10 and the saw blade 11 for water to flow out. Another passage, which is also communicated with the water outlet hole 124, is reserved between the connecting seat 122 and the saw blade 11 for water to flow out. In practical applications, the number of water outlet holes 124 is two, which are coaxially arranged on the central shaft 121. The aperture of the water outlet hole 124 ensures that when the saw blade 11 is placed at the water outlet hole 124, the cooling water flows out from both sides of the saw blade 11. At the same time, a plurality of water outlet holes 124 may be provided on both sides of the saw blade 11, or setting a chamfer at the edge of the water outlet hole 124 to ensure that the cooling water flows out from both sides of the saw blade 11.

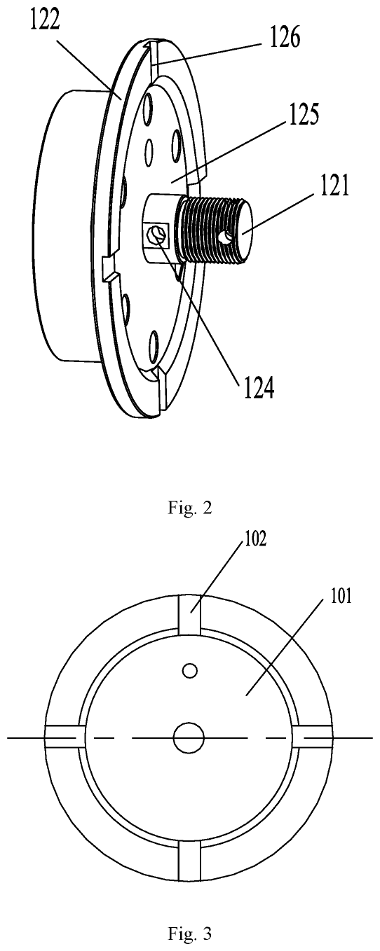

Referring to FIG. 2, a second water storage groove 125 is provided on a side of the saw blade mounting shaft 12 near the saw blade 11, and a cavity for storing water is formed between the second water storage groove 125 and the saw blade 11. The edge of the saw blade mounting shaft 12 is evenly provided with a plurality of second drainage grooves 126, which are in communication with the second water storage groove 125. Referring to FIG. 3, a first water storage groove 101 is provided on a side of the flange plate 10 near the saw blade 11, and a cavity for storing water is formed between the first water storage groove 101 and the saw blade 11. The edge of the flange plate 10 is evenly provided with a plurality of first drainage grooves 102, and the first drainage grooves 102 are in communication with the first water storage groove 101.

In the embodiment of the present invention, when the flange plate 10 and the connecting seat 122 are arranged on both sides of the saw blade 11, the positions of the first water storage groove 101 and the second water storage groove 125 are opposite to each other, and the positions of the first drainage groove 102 and the second drainage groove 126 are opposite to each other. The cooling water flows out of the water outlet hole 124, enters the first water storage groove 101 and the second water storage groove 125, and then discharges through the first drainage groove 102 and the second drainage groove 126 under the action of the inertial centrifugal force of the rotation of the saw blade 11.

A sealing ring assembly 7 is provided at the joint between the fastening bolt 3 and the central shaft 121. The seal ring assembly 7 comprises a first seal ring 71, a second seal ring 72, and a third seal ring 73. The first seal ring 71 is a rubber seal ring, the second seal ring 72 is a ceramic seal ring, and the third seal ring 73 is a rubber seal ring. The second seal ring 72 is located between the first seal ring 71 and the third seal ring 73. In the embodiment of the present invention, the second sealing ring 72 is the transition section of the butt joint between the fastening bolt 3 and the central shaft 121. In practical application, the sealing ring can also be directly set at the butt joint of the fastening bolt 3 and the central shaft 121 to prevent water overflow. A groove matching with the first sealing ring 71 is arranged on the transmission shaft 14, and the first sealing ring 71 is placed in the groove to ensure that the first sealing ring 71 is mounted more firmly and is not easy to loosen. A spring 15 is sleeved on the central shaft 121, one side of the spring 15 abuts on the connecting seat 122, and the other side abuts on the seal ring assembly 7 to prevent the seal ring assembly 7 from loosening 7. The spring 15 abuts on the third seal ring 73. The fastening bolt 3 is provided with a water jacket 2 for connecting to an external water pipe 1, and the water jacket 2 is communicated with the first through hole 31. The flange plate 10 is fixed on the central shaft 121 through a nut 8, and the connecting seat 122 is fixed on the belt pulley 13 through a plurality of screws 6. The saw blade 11 is fixed on the connecting seat 122 through the saw blade positioning pin 9 to prevent the saw blade 11 from slipping during the cutting operation.

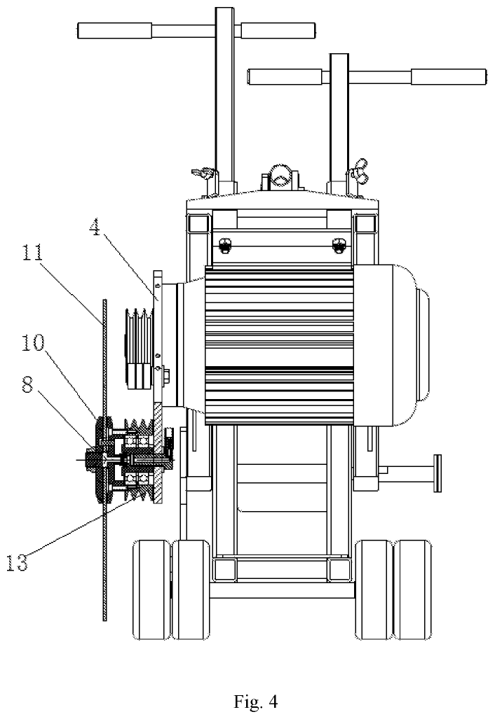

Referring to FIG. 4, the present invention further provides a road cutting machine, which comprises the above water cooling device. The saw blade 11 is mounted on the water cooling device. The water cooling device is fixedly connected to a motor of the road cutting machine through a fixing plate 4. The fixing plate 4 is fixedly connected to the transmission shaft 14. The fastening bolt 3 passes through the fixing plate 4.

In practical use, the saw blade 11 is sleeved on the central shaft 121 of the saw mounting shaft 12 and the saw blade 11 is positioned by the saw positioning pin 9. Then, the flange plate 10 is sleeved on the central shaft 121 of the saw blade mounting blade 12, and screwed with the central shaft 121 through the nut 8 to fix the saw blade 11 and the flange plate 10. In the operation of the road cutting machine, the motor drives the belt pulley 13 to rotate through a belt, and simultaneously drives the saw blade 11 to rotate. The cooling water from the water pipe 1 through the water jacket 2 enters the first through hole 31 of the fastening bolt 3, then flows into the second through hole 123 of the central shaft 121, and then flows out of the water outlet hole 124 to the first water storage groove 101 and the second water storage groove 125. Through the inertial centrifugal force of the rotation of the saw blade 11, cooling water is discharged from the first drainage groove 102 and the second drainage groove 126 respectively, to effectively cool the saw blade.

One skilled in the art may make a number of improvements and modifications without departing from the principle of the present invention, and these improvements and modifications are also considered to be within the protection scope of the present invention. The contents that are not described in detail in the description belong to the prior art well known by one skilled in the art.

1. A water cooling device for saw blade cooling, comprising: a saw blade mounting shaft (12), a transmission shaft (14) and a belt pulley (13), wherein a saw blade (11) is mounted on the saw blade mounting shaft (12), the belt pulley (13) is sleeved on the transmission shaft (14), a bearing (5) is provided between the belt pulley (13) and the transmission shaft (14), and the saw blade mounting shaft (12) is fixed on one end of the belt pulley (13); wherein the water cooling device further comprises a fastening bolt (3) and a flange plate (10), and the saw blade mounting shaft (12) comprises a central shaft (121) and a connecting seat (122);
the fastening bolt (3) is provided with a first through hole (31) for water to flow in, and the central shaft (121) is provided with a second through hole (123), and the fastening bolt (3) passes through the transmission shaft (14) to be butt-jointed with the central shaft (121), so that the first through hole (31) is communicated with the second through hole (123);
the flange plate (10) is arranged on the central shaft (121), and the saw blade (11) is located between the flange plate (10) and the connecting seat (122); the central shaft (121) is provided with at least one water outlet hole (124), which is located between the flange plate (10) and the connecting seat (122) and communicated with the second through hole (123); a passage in communication with the water outlet hole (124) is reserved between the flange plate (10) and the saw blade (11) and a passage in communication with the water outlet hole (124) is reserved between the connecting seat (122) and the saw blade (11).

2. The water cooling device for saw blade cooling according to claim 1, wherein a first water storage groove (101) is arranged on a side of the flange plate (10) near the saw blade (11), and a cavity for storing water is formed between the first water storage groove (101) and the saw blade (11); the edge of the flange plate (10) is evenly provided with a plurality of first drainage grooves (102), which are in communication with the first water storage groove (101);
a second water storage groove (125) is arranged on a side of the saw blade mounting shaft (12) near the saw blade (11), and a cavity for storing water is formed between the second water storage groove (125) and the saw blade (11); the edge of the saw blade mounting shaft (12) is evenly provided with a plurality of second drainage grooves (126), which are in communication with the second water storage groove (125).

3. The water cooling device for saw blade cooling according to claim 2, wherein when the flange plate (10) and the connecting seat (122) are arranged on both sides of the saw blade (11), the positions of the first water storage groove (101) and the second water storage groove (125) are opposite to each other and the first drainage groove (102) and the second drainage groove (126) are opposite to each other.

4. The water cooling device for saw blade cooling according to claim 1, wherein a sealing ring assembly (7) is provided at the joint between the fastening bolt (3) and the central shaft (121).

5. The water cooling device for saw blade cooling according to claim 4, wherein the seal ring assembly (7) comprises a first seal ring (71), a second seal ring (72), and a third seal ring (73), wherein the first seal ring (71) is a rubber seal ring, the second seal ring (72) is a ceramic seal ring, and the third seal ring (73) is a rubber seal ring, and the second seal ring (72) is located between the first seal ring (71) and the third seal ring (73).

6. The water cooling device for saw blade cooling according to claim 5, wherein a groove matching with the first sealing ring (71) is provided on the transmission shaft (14), and the first sealing ring (71) is placed in the groove.

7. The water cooling device for saw blade cooling according to claim 4, wherein a spring (15) is sleeved on the central shaft (121), one side of the spring (15) abuts on the connecting seat (122), and the other side abuts on the seal ring assembly (7).

8. The water cooling device for saw blade cooling according to claim 1, wherein the fastening bolt (3) is provided with a water jacket (2) for externally connecting to a water pipe (1), and the water jacket (2) is communicated with the first through hole (31).

9. The water cooling device for saw blade cooling according to claim 1, wherein the flange plate (10) is fixed on the central shaft (121) through a nut (8), the connecting seat (122) is fixed on the belt pulley (13) through a plurality of screws (6), and the saw blade (11) is fixed on the connecting seat (122) through the saw blade positioning pin (9).

10. A road cutting machine, comprising the water cooling device according to of claim 1, wherein the saw blade (11) is mounted on the water cooling device, which is fixedly connected to a motor of the road cutting machine through a fixing plate (4), the fixing plate (4) is fixedly connected to the transmission shaft (14), and the fastening bolt (3) passes through the fixing plate (4).
